(19) United States
(12) Patent Application Publication
(10) Pub. No.: US 2020/0402012 A1
(43) Pub. Date: Dec. 24, 2020

(54) MULTI-OBJECTIVE OPTIMIZATION OF JOB APPLICATIONS REDISTRIBUTION

(71) Applicant: Microsoft Technology Licensing, LLC., Redmond, WA (US)

(72) Inventors: Chunzhe Zhang, Sunnyvale, CA (US); Krishnaram Kenthapadi, Sunnyvale, CA (US); Boyu Zhang, San Francisco, CA (US); Bimal Sundaran Parakkal, Burlingame, CA (US); Hai Jian Guan, San Mateo, CA (US)

(21) Appl. No.: 16/445,862

(22) Filed: Jun. 19, 2019

(51) Int. Cl. G06Q 10/10; G06F 16/2457; G06F 16/9035; G06N 20/00

(52) U.S. Cl. CPC G06Q 10/1053; G06N 20/00; G06F 16/9035; G06F 16/24578

(57) ABSTRACT

A technical problem of multi-objective optimization of job applications redistribution in an online connection network system is addressed by incorporating monetary value of job applications as a signal into a ranker for ranking jobs with respect to a member profile in job search and recommendations. The monetary value of job applications is used in addition to the relevance signal and is determined by executing a machine learning model that accounts for the covariates that could impact monetary value of an application for a job.

### TECHNICAL FIELD

This application relates to the technical fields of software and/or hardware technology and, in one example embodiment, to system and method for multi-objective optimization of job applications redistribution in an online connection network system.

### BACKGROUND

An online connection network system is a platform for connecting people in virtual space. An online connection network system may be a web-based platform, such as, e.g., a connection networking web site, and may be accessed by a user via a web browser or via a mobile application provided on a mobile phone, a tablet, etc. An online connection network system may be a business-focused connection network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a connection networking web site may emphasize employment history and professional skills of the associated member. An online connection network system is also designed to allow job posters (e.g., companies) to post job openings such that the job openings (also referred to as simply jobs) can be surfaced to members, e.g., as search results in response to a search submitted by a member to the online connection network system or as recommendations that can appear in a member's news feed. Recommended jobs are presented to a member via a user interface (UI) that permits the member to view the details of the job and also to apply to the job electronically.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system for multi-objective optimization of job applications redistribution in an online connection network system may be implemented;

FIG. 2 is a block diagram of an architecture for multi-objective optimization of job applications redistribution in an online connection network system, in accordance with one example embodiment;

FIG. 3 is a flowchart illustrating a method for multi-objective optimization of job applications redistribution, in accordance with an example embodiment; and

FIG. 4 is a diagrammatic representation of an example machine in the form of a computer system within which a set of instructions, for causing the machine to perform any one or more of the methodologies discussed herein, may be executed.

### OVERVIEW

A method and system for multi-objective optimization of job applications redistribution in an online connection network system are described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrases “an online connection networking application” and “an online connection network system” may be referred to as and used interchangeably with the phrase “an online connection network” or merely “a connection network.” It will also be noted that an online connection network may be any type of an online connection network, such as, e.g., a professional network, an interest-based network, or any online networking system that permits users to join as registered members. A member is represented in an online connection network system by a member profile that may include various information such as, e.g., the name of a member, current and previous geographic location of a member, current and previous employment information of a member, information related to education of a member, information about professional accomplishments of a member, publications, patents, as well as information about the member's professional skills. Each member of an online connection network is represented by a member profile (also referred to as a profile of a member or simply a profile). As mentioned above, an online connection network system may be designed to allow registered members to establish and document networks of people they know and trust professionally. Any two members may indicate their mutual willingness to be “connected” in the context of the online connection network system, in that they can view each other's profiles, profile recommendations and endorsements for each other and otherwise be in touch via the online connection network system. Members who are connected in the context of an online connection network system may be termed each other's “connections” and their respective profiles are associated with respective connection links indicative of these two profiles being connected.

In the online connection network system, as mentioned above, jobs can be surfaced to members via a UI that permits the member to view the details of the job and also to apply to the job electronically. A situation may arise, however, where jobs that are more popular in terms of the members' interest receive more applications while less popular jobs barely receive any applications due to lack of awareness from job seekers. As a result, the job marketplace facilitated by the online connection network system may become unbalanced, which could be less effective and even frustrating for both job seekers and job posters.

The intuition is that it would be desirable to redistribute job applications from over-popular jobs to jobs currently with limited number of applications, and that such redistribution would satisfy multiple objectives: (1) result in the increased likelihood of job posters posting jobs, for a fee, with the online connection network, while (2) without negatively impacting the LTV of job posters who post popular jobs, LTV—lifetime value—is an estimate of the projected total value of a customer over its lifetime (or a predetermined period of time, e.g., one year) in the context of SaaS (software as a service).

The technical problem of multi-objective optimization of job applications redistribution in an online connection network system is addressed by incorporating monetary value of job applications as a signal into a ranker for ranking jobs with respect to a member profile in job search and recommendations.

The monetary value can be estimated and assigned to each subsequent job application using the intuition that, for job posters, in terms of ROI, there is not so much difference in receiving 200 applications or 300 applications for a job, while there may be a huge difference, in terms of ROI, between receiving 0 and 10 applications for a given job. Because job posters pay to the provider of the online connection network system for the service that permits them to post jobs with the online connection network system (a job posting service), they expect to get return on investment (ROI), one measure of which is the number of applications for a given job received via the UI that permits members apply to a job electronically. While intuitively it makes sense that the earlier applications for a given job have higher monetary values than the later ones (diminishing return pattern), there is no existing methodology for automatically predicting a monetary value of each subsequent application for a given job, based on the specifics of that particular job.

The technical problem of automatically predicting monetary value of each subsequent application that has been effectuated for a job posted with the online connection network system is addressed by developing a machine learning model that accounts for the covariates that could impact monetary value of an application for a job and also incorporate the diminishing return pattern.

The estimations of monetary value of each subsequent application that has been effectuated for a job via a UI provided by the online connection network system can be used for various purposes, e.g., as a signal into a machine learning model that automatically generates price adjusting factors for company customers in different segments, such as, e.g., different geographic locations, different industries and different company sizes. The intuition is that companies (customers that post jobs with the online connection network system) that are in different segments may be deriving different value from posting jobs with the online connection network system and may have different expectations as to how much they should pay for the job posting service.

The technical problem of automatically predicting an optimal fee a given company customer should be expected to pay for the job posting service is addressed by developing a machine learning model (price optimization model) that could automatically generate price adjusting factors for company customers in different segments.

### DETAILED DESCRIPTION

The ranker provided with the online connection network system and that is designed to facilitate multi-objective optimization of job applications redistribution takes, as input, the estimated monetary value of the next application for a given job, and also the estimated CTR (click through rate) that represents likelihood that a viewer clicks on (or otherwise interacts with) the job if the job is surfaced to the viewer via a UI provided by the online connection network system. The estimated. CTR for a job with respect to a member profile is produced by a relevance model that takes, as input, features of the job and features of the member profile, the member profile representing a member for whom the job would potentially surfaced. As such, the ranker ranks jobs based on the relevance-preserving score that optimizes utilities of both job seekers and job posters as well as the revenue of the provider of the online connection network system. Such relevance-preserving utility-driven score penalizes over-popular jobs and boosts jobs with limited number of job applications smoothly and without hurting relevance of recommended jobs. All parameters in this system, such as a basting coefficient, can be automatically tuned.

In some embodiments, the generating of a rank a job is expressed by Equation (1) below.

Rank=CTR×$ Value of Application×α×I(CTR≥h)+CTR×I(CTR<h), Equation (1)

where CTR represents likelihood that a viewer clicks on (or otherwise interacts the job if the job is surfaced to the viewer,
$ Value of Application is the estimated monetary value of the next application for the job,
α and h are tuning parameters that control the trade-off between relevance and application value, a can be referred to as a basting coefficient and h can be referred to as a relevance threshold.

The I( ) function is the indicator function:
I(CTR≥h)=1 if CTR≥h, otherwise I(CTR≥h)=0
I(CTR<h)=1 if CTR<h, otherwise I(CTR<h)=0

For example, if the estimated CTR for a job with respect to a member profile is greater than or equal to h, then the Rank for the job is calculated as the product of the estimated CTR, the value of the next application for that job, boosted by the boosting coefficient α. If, however, the estimated CTR for a job with respect to a member profile is less than h, then the Rank for the job is assigned the estimated CTR.

In some embodiments, the final values of tuning parameters are determined by experimentation and statistical techniques; those techniques are frequently used in machine learning tasks. A list of candidate values for tuning parameters are calculated by checking the empirical distribution of CTRs and $ Value of Application.

The monetary value of a job application, notated as $ Value of Application in Equation (1) above, can be defined as follows: if the number of job applications increased by 1, how much more money the customer (the poster of the job) is predicted to spend in the future. Based on the historical data, a diminishing return pattern has been detected between customers' LTV and the number of job applications received with respect to jobs posted by the customer. The monetary value of job applications is modelled through a linear-log mixed model where the response is job posters' LTV over a predetermined period and the covariates include the (log transformed) number of job applications as well as other job/company/job poster features that may impact job posters' LTV, such as industry, country, company size, and customer loyalty. Interaction terms between number of job applications and other covariates are included into the model in order to accommodate the fact that the shape of the diminishing curve would vary in different market segments (industry, country, etc.).

In some embodiments, the generating of a job posters' LTV using the fitted model, is expressed by Equation (2) below.

y=α+Σᵢβᵢ*xᵢ+γ*log(n)+Σᵢδᵢ*xᵢ*log(n)+ε, y=α+Σᵢβᵢ*xᵢ+γ*log(n)+Σᵢδᵢ*xᵢ*log(n)+ε Equation (2)

where xᵢ is job/company/job poster feature included in the model,
n is number of job applications previously received,
ε is an error term,
α, βᵢ, γ, δᵢ are covariates that are learned/estimated using machine learning techniques.

For a given job, the difference between the predicted LTV for n^{th} job applications and the predicted LTV for n−1^{th} job application is the monetary value of the n^{th} job application, which is notated in Equation (1) above as $ Value of Application.

The estimations of monetary value of each subsequent application that has been effectuated fir a job via a UI provided by the online connection network system can be used, as mentioned above, as a signal into a machine learning model that automatically generates price adjusting factors for company customers in different segments. This machine learning model is formulated as an optimization problem expressed by Equation 3 below.

$${min}_{w} {\sum }_{j} {\sum }_{i ∈ {S}_{j}} \frac{1}{{NPS}_{ji}} {( {w}_{j} * {p}_{ji} - {JA}_{ji} )}^{2} such that {w}_{j} > 0 , \qquad Equation ( 3 )$$

where j is the company customer segment index, Sⱼ includes all company customer indexes in segment j, NPSⱼᵢ is the NPS score of customer i in segment j, pⱼᵢ is the price customer paid during the investigation period, JAⱼᵢ is the total value of job applications delivered to customer by the online connection network system during the investigation period, wⱼ is the adjusting factor that is being optimized by the price optimization model.

The Net Promoter Score (NPS) is the likelihood that a customer would recommend the service to someone else. The machine learning model formulated as an optimization problem expressed by Equation (3) leverages NPS to assign more weights to customers who give low satisfaction score—so that the model could focus more on minimizing the distance between what they paid to have their jobs posted with the online connection network system and the value they received in return.

Once the optimized w*=(w₁*, . . . , wⱼ*), is obtained, job slot price for segment j is adjusted by

$$\frac{{w}_{j}^{*}}{median ( {w}^{*} )} .$$

The total value of job applications delivered to the customer is calculated and the sum pf values of each received application for a given job.

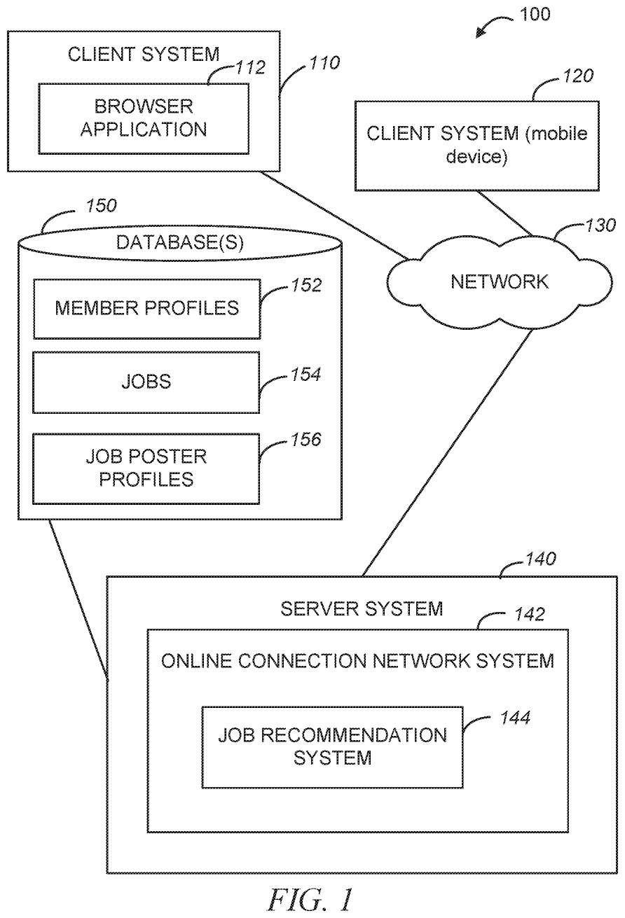

An example job recommendation system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an online connection network system 142. As explained above, each member of an online connection network is represented by a member profile that contains personal and professional information about the member and that may be associated with connection links that indicate the member's connection to other member profiles in the online connection network. Member profiles and related information may be stored in a database 150 as member profiles 152. The database 150 also stores other entities, such as jobs 154 and job poster profiles 156.

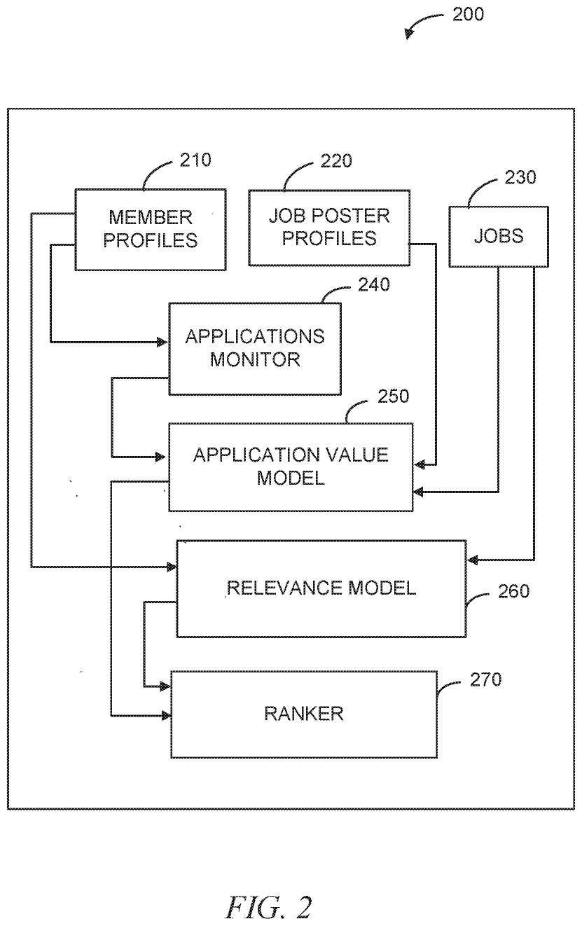

The client systems 110 and 120 may can access the server system HO via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a job recommendation system 144. The job recommendation system 144 is configured for multi-objective optimization of job applications redistribution in an online connection network, by applying methodologies discussed herein. Example architecture of the job recommendation system 144 is illustrated in FIG. 2.

FIG. 2 is a block diagram of an architecture 200 used by the job recommendation system 144 of FIG. 1 for multi-objective optimization of job applications redistribution in an online connection network. As shown in FIG. 2, the architecture 200 includes stored data of various entity types—member profiles 210, job poster profiles 220, and jobs 230. Job poster profiles represent companies that post jobs with the online connection network system. A company from job poster profiles is associated with a plurality of jobs posted with the online connection network system and also associated with one or more segment features. The one or more segment features include, e.g., one or more of geographic location, industry, and company size.

An applications monitor 240 is configured to monitor events indicative of applications for jobs by members represented by member profiles. An application value model 250, which is described above with reference to Equation (2), uses the number of previously-occurred applications for a job monitored by the applications monitor 240 to estimate a value of a next application for the job. Other signals used as input into application value model 250 are features of the job and features of the job poster.

As explained above, for a given job, the difference between the output of the application value model 250 (predicted LTV) for n^{th} job application and the output of the application value model 250 for (n−1^{th}) job application is the monetary value of the n^{th} job application. The value of a next application, together with the estimated relevance of a job with respect to a member profile is used as input to the ranker 270. The estimated relevance of a job with respect to a member profile, notated as CTR in Equation (1), is produced by a relevance model 260. The relevance of the job, CTR, is probability of the member interacting with the job via a user interface provided by the online connection network system.

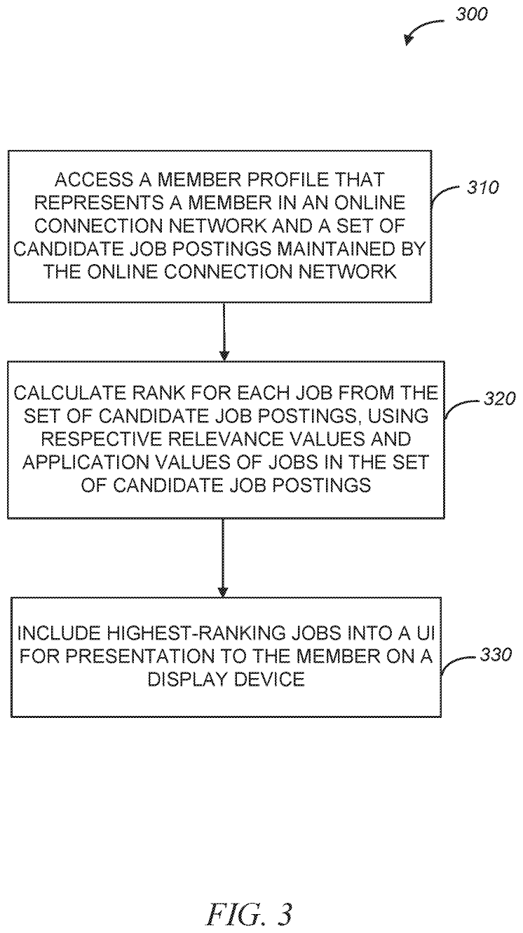

The ranker 270 generates respective ranks for jobs that have been identified as being potentially of interest to a member, such that the highest-ranking jobs are surfaces to the member via a UI generated by the online connection network system. Some operations performed by the job recommendation system 144 may be described with reference to FIG. 3.

FIG. 3 is a flowchart of a method 300 for multi-objective optimization of job applications redistribution in an online connection network 142 of FIG. 1. The method 300 may be performed by processing logic that may comprise hardware (e.g., dedicated logic, programmable logic, microcode, etc.), software, or a combination of both. In one example embodiment, the processing logic resides at the server system 140 of FIG. 1.

As shown in FIG. 3, the method 300 commences at operation 310, by accessing a member profile that represents a member in an online connection network and a set of candidate job postings maintained by the online connection network. Each job in the set of candidate job postings is an electronic listing of a job opening, which includes job features, such as information about the company, required skills, job title, etc. At operation 320, rank is calculated for each job from the set of candidate job postings, by the ranker 270 of FIG. 2. The calculating of a rank for a job includes determining a value of a next application for the job using the application value model 250 of FIG. 2, executing a relevance machine learning model 260 of FIG. 2 to predict relevance of the job, and calculating a rank of the job by multiplying the relevance of the job by the value of the next application for the job. The determining of the value of the next application for the job comprises executing an application value machine learning model (shown as block 250 in FIG. 2) to predict projected value associated with a job poster of the job (LTV of the job poster) and calculating the value of the next application for the job as the difference between the projected value associated with the job poster of the job and a previously-predicted projected value associated with the job poster of the job (previously-predicted projected LTV).

In some embodiments, the rank is calculated using Equation (I) discussed above, where jobs with the predicted CRT below a certain threshold are assigned the rank that equals their predicted CTR, while jobs with the predicted CRT above a certain threshold are assigned the rank that equals the product of the predicted. CTR and the value of the next application boosted by a predetermined coefficient. At operation 330, the highest-ranking jobs are included into a UI for presentation to the member on a display device.

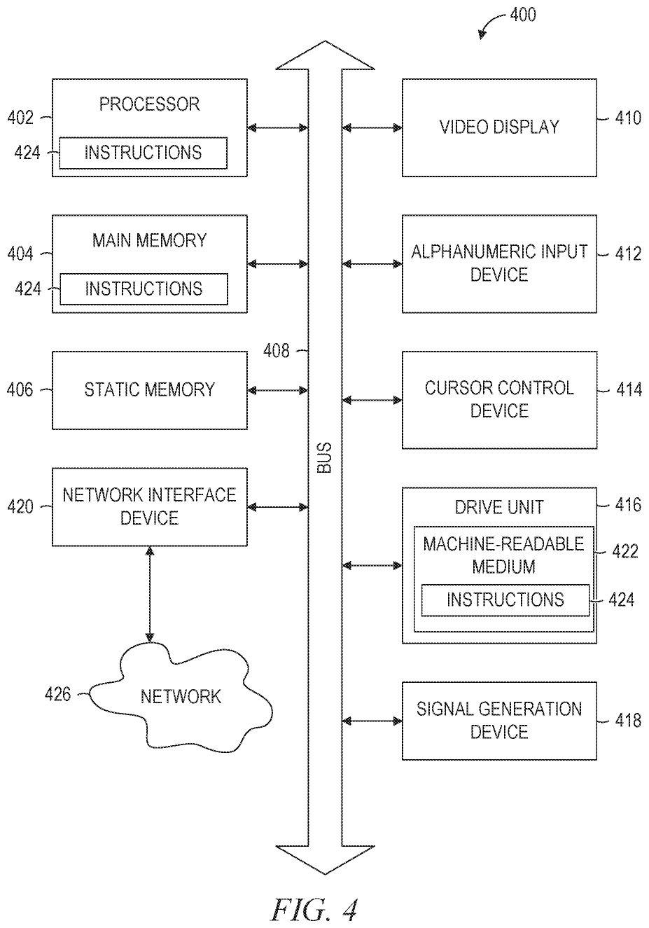

FIG. 4 is a diagrammatic representation of a machine in the example form of a computer system 400 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 404. The computer system 400 may further include a video display unit 410 (e.g., a liquid crystal display (LCD) or a cathode ray tube (CRT)). The computer system 400 also includes an alpha-numeric input device 412 (e.g., a keyboard), a user interface (UI) navigation device 414 (e.g., a cursor control device), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, with the main memory 404 and the processor 402 also constituting machine-readable media.

The software 424 may further be transmitted or received over a network 426 via the network interface device 420 utilizing any one of a number of well-known transfer protocols (e.g., Hyper Text Transfer Protocol (HTTP)).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) be driven by cost and time considerations.

Accordingly, the term “hardware-implemented module” should be understood to encompass a tangible thing, be that a thing that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program interfaces (APIs).)

Thus, a method and system for multi-objective optimization of job applications redistribution in an online connection network has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer implemented method comprising:
accessing a member profile that represents a member in an online connection network and a set of candidate job postings maintained by the online connection network, each job in the set of candidate job postings is an electronic listing of a job opening comprising job features;
for jobs from the set of candidate job postings:
determining a value of a next application for the job,
executing a relevance machine learning model to predict relevance of the job,
calculating a rank of the job by multiplying the relevance of the job by the value of the next application for the job; and
including a subset of jobs from the set of candidate job postings, based on their respective ranks, into a user interface (UI) for presentation to the member on a display device.

2. The method of claim 1, wherein the determining of the value of the next application for the job comprises:
executing an application value machine learning model to predict projected value associated with a job poster of the job; and
calculating the value of the next application for the job as the difference between the projected value associated with the job poster of the job and a previously-predicted projected value associated with the job poster of the job.

3. The method of claim 2, comprising using a number of previously occurred applications for the job, features of the job and features of the job poster as input to the application value machine learning model.

4. The method of claim 2, wherein the application value a e learning model is a linear-log mixed model.

5. The method of claim 1, wherein the relevance of the job is probability of the member interacting with the job via a user interface provided by the online connection network system.

6. The method of claim 1, wherein the online connection network system maintains a set of job poster profiles, a company from job poster profiles associated with a plurality of jobs posted with the online connection network system and also associated with one or more segment features.

7. The method of claim 6, wherein the one or more segment features include one or more of geographic location, industry, and company size.

8. The method of claim 6 further comprising executing a price adjusting machine learning model with respect to the set of job poster profiles to generate respective price adjusting factors for companies in the set of job poster profiles.

9. The method of claim 1, wherein the price adjusting machine learning model takes as input respective net promoter scores of companies in the set of job poster profiles, respective fees charged to companies in the set of job poster profiles during an investigation period, and respective total values of job applications received by respective companies in the set of job poster profiles during the investigation period.

10. The method of claim 1, wherein the relevance machine learning model takes as input features of the job and features of the member profile.

11. A system comprising:
one or more processors; and
a non-transitory computer readable storage medium comprising instructions that when executed by the one or processors cause the one or more processors to perform operations comprising:
accessing a member profile that represents a member in an online connection network and a set of candidate job postings maintained by the online connection network, each job in the set of candidate job postings is an electronic listing of a job opening comprising job features;
for jobs from the set of candidate job postings:
determining a value of a next application for the job,
executing a relevance machine learning model to predict relevance of the job,
calculating a rank of the job by multiplying the relevance of the job by the value of the next application for the job; and
including a subset of jobs from the set of candidate job postings, based on their respective ranks, into a user interface (UI) for presentation to the member on a display device.

12. The system of claim 11, wherein the determining of the value of the next application for the job comprises:
executing an application value machine learning model to predict projected value associated with a job poster of the job; and
calculating the value of the next application for the job as the difference between the projected value associated with the job poster of the job and a previously-predicted projected value associated with the job poster of the job.

13. The system of claim 12, comprising using a number of previously occurred applications for the job, features of the job and features of the job poster as input to the application value machine learning model.

14. The system of claim 12, wherein the application value machine learning model is a linear-log mixed model.

15. The system of claim 11, wherein the relevance of the job is probability of the member interacting with the job via a user interface provided by the online connection network system.

16. The system of claim 11, wherein the online connection network system maintains a set of job poster profiles, a company from job poster profiles associated with a plurality of jobs posted with the online connection network system and also associated with one or more segment features.

17. The system of claim 16, wherein the one or more segment features include one or more of geographic location, industry, and company size.

18. The system of claim 16 further comprising executing a price adjusting machine learning model with respect to the set of job poster profiles to generate respective price adjusting factors for companies in the set of job poster profiles.

19. The system of claim 11, wherein the price adjusting machine learning model takes as input respective net promoter scores of companies in the set of job poster profiles, respective fees charged to companies in the set of job poster profiles during an investigation period, and respective total values of job applications received by respective companies in the set of job poster profiles during the investigation period.

20. A machine-readable non-transitory storage medium having instruction data executable by a machine to cause the machine to perform operations comprising:
accessing a member profile that represents a member in an online connection network and a set of candidate job postings maintained by the online connection network, each job in the set of candidate job postings is an electronic listing of a job opening comprising job features;
for jobs from the set of candidate job postings:
determining a value of a next application for the job,
executing a relevance machine learning model to predict relevance of the job,
calculating a rank of the job by multiplying the relevance of the job by the value of the next application for the job; and
including a subset of jobs from the set of candidate job postings, based on their respective ranks, into a user interface (UI) for presentation to the member on a display device.
